(19) United States
(12) Patent Application Publication
(10) Pub. No.: US 2013/0060710 A1
(43) Pub. Date: Mar. 7, 2013

(54) System, Method and Apparatus for Managing and Conducting Property Inspections

(71) Applicants: Matthew Preuss, Rochester Hills, MI (US); Jerry Hosack, Macomb Twp, MI (US); Najah Manni, Henderson, NV (US); John Musinski, Lake Orion, MI (US); Michael McGrath, Clarkston, MI (US)

(72) Inventors: Matthew Preuss, Rochester Hills, MI (US); Jerry Hosack, Macomb Twp, MI (US); Najah Manni, Henderson, NV (US); John Musinski, Lake Orion, MI (US); Michael McGrath, Clarkston, MI (US)

(21) Appl. No.: 13/462,540

(22) Filed: May 2, 2012

Related U.S. Application Data
(60) Provisional application No. 61/482,470, filed on May 4, 2011.

(51) Int. Cl. G06Q 50/16

(52) U.S. Cl. 705/314

(57) ABSTRACT

A system for managing property inspections may include a base computer and a memory unit coupled to the base computer. The memory unit may have stored therein a plurality of property inspection requests and a number of property inspector records, with each of the plurality of property inspection requests including at least one attribute of a corresponding property to be inspected and with each of the number of property inspector records including data associated with a corresponding property inspector, and instructions that are executable by the base computer to assign the property inspection requests to the property inspectors based on matches between the at least one attribute of the plurality of property inspection requests and at least one of the data associated with the number of property inspection records. The property inspectors may access their assignments of property inspections through a web portal.

### CROSS-REFERENCE TO RELATED APPLICATIONS

This patent application claims the benefit of, and priority to, Provisional Patent Application Ser. No. 61/482,470, filed May 4, 2011, the disclosure of which is incorporated herein by reference.

### FIELD OF THE INVENTION

The present invention relates generally to the field of property inspections, and more specifically to systems, methods and apparatuses for managing and conducting such property inspections

### BACKGROUND

Property inspections are conventionally conducted by filling out property inspection survey forms, e.g., by manually entering property inspection information onto one or more hard-copy property inspection survey forms, during the course of a property inspection, and then generating a report of the property inspection. It is desirable to automate at least some of the property inspection process, and to further automate the management of data associated with property inspections.

### BRIEF DESCRIPTION OF THE DRAWINGS

FIG. 1 is a system-level diagram of one illustrative embodiment of a system for managing and conducting property inspections.

FIG. 2 is a flowchart of one illustrative process for managing property inspections, property inspectors and property inspection data.

FIG. 3 is a flowchart of one illustrative process for managing property inspections and property inspection assignments using the property inspector portal illustrated in FIG. 1.

FIG. 4 is a flowchart of one illustrative process for conducting property inspections using a mobile electronic device.

FIG. 5 is a flowchart of one alternative process for conducting property inspections using a conventional property survey and the property inspector portal illustrated in FIG. 1.

FIG. 6A is a flowchart of one illustrative process for registering a mobile electronic device with the system of FIG. 1 for the purpose of conducting secure property inspections.

FIG. 6B is a mobile electronic device illustrating an example display, on a display screen thereof, associated with the process illustrated in FIG. 6A.

FIGS. 7A and 7B show a flowchart of one illustrative process for conducting property inspections using a mobile electronic device.

FIGS. 7C, 7D and &E show a mobile electronic device illustrating example displays, on a display screen thereof, associated with the process illustrated in FIGS. 7A-7B.

FIG. 8 is a flowchart of one illustrative process for managing property inspection data by lenders using the lender portal illustrated in FIG. 1.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

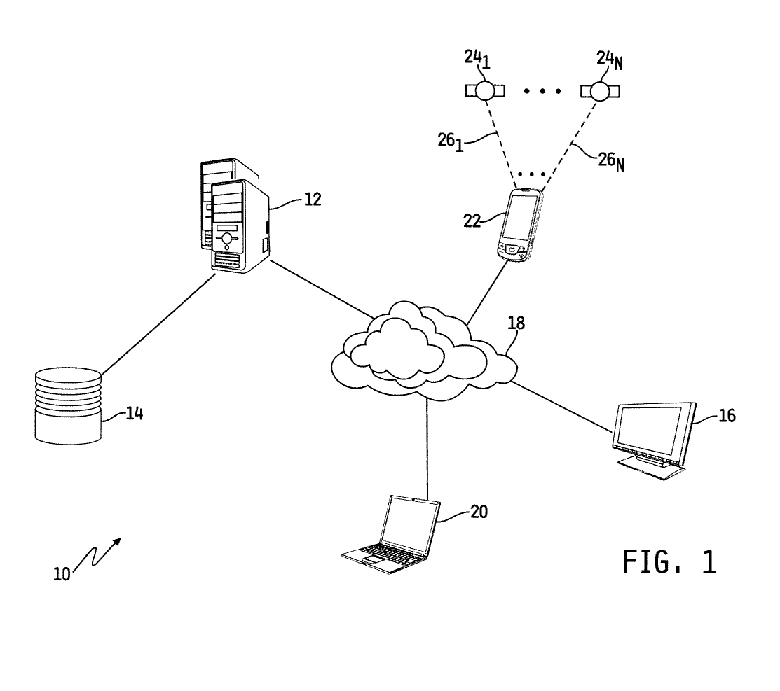

Referring now to FIG. 1, a diagram is shown of one illustrative embodiment of a system 10 for managing and conducting property inspections. In the illustrated embodiment, the system 10 includes a base computer 12, e.g., in the form of one or more servers, coupled to one or more memory units 14. The base computer 12 may be a conventional computer or computer system resident in a facility, or may alternatively be, or be supplemented by, one or more remote computer systems via a so-called “cloud” architecture. In any case, the memory 14 illustratively has stored therein a process in the form of one or more sets of instructions that is/are executable by the base computer 12 to control and manage property inspections and property inspection-related data. The base computer 12 is configured in a conventional manner to share information with other systems and/or devices via the World Wide Web (WWW), or “Internet,” 18.

The system 10 further includes a lender/service provider portal or gateway 16 via which approved lenders and/or other service providers may securely access a lender/service provider website controlled and managed by the base computer 12. Approved lenders/service providers may access the portal 16 via the WWW 18 using, for example, a conventional desktop, laptop, notebook, tablet or other computer and/or via a conventional portable or handheld electronic communication device that is configured to access the WWW 18. The memory unit 14 has stored therein one or more sets of instructions executable by the base computer 12 to control and manage the lender/service provider website, and the lender/service provider website is illustratively configured to allow lenders and/or service providers to access, view, and obtain reports on campaign and account information via the lender/service provider portal 16.

The system 10 further includes an agent portal or gateway 20 via which approved property inspectors may securely access a property inspector website controlled and managed by the base computer 12. Approved property inspectors may access the portal 20 via the WWW 18 using, for example, a conventional desktop, laptop, notebook, tablet or other computer and/or via a conventional portable or handheld electronic communication device that is configured to access the WWW 18. The memory unit 14 has stored therein one or more sets of instructions executable by the base computer 12 to control and manage the property inspector website, and the property inspector website is illustratively configured to allow property inspectors to manage property inspection assignments and property inspection data via the agent portal 20. The term “approved property inspectors” will be understood to mean one or more property inspectors that have pre-established secure access to the portal 20, and that have been provided with corresponding access information, e.g., in the form of one or more of a user name, password, and/or the like.

The system 10 may further include one or more portable or hand-held mobile electronic devices 22 which may be used by property inspectors to conduct property inspections and which is/are configured to share collected property inspection data with the base computer 12 via the WWW 18. The mobile electronic devices 22 illustratively include conventional Global Positioning Satellite (GPS) receivers and software configured to receive and process a plurality of GPS radio signals 26₁-26_{N} produced by a corresponding plurality of earth-orbiting Global Positioning Satellites 24₁-24_{N}, where N is a positive integer, e.g., 24. The mobile electronic devices 22 are thus configured to determine global coordinates, e.g., latitude, longitude and altitude, as well as real time information, from the radio signals produced by the satellites 24₁-24_{N}. In embodiments that include the one or more mobile electronic devices 22, the one or more devices 22 each include a conventional processor and sufficient memory having stored therein one or more sets of instructions, e.g., in the form of a user application or “app,” executable by the processor to guide a property inspector through a property inspection. Examples of mobile electronic devices 22 that may be used with the system 10 include, but should not be limited to, conventional smart phones, personal communication devices (PDAs), application-specific mobile electronic devices and/or other mobile electronic devices having sufficient memory and computing power to execute a set of instructions that guide property inspectors through property inspections, and configured to pass collected property inspection data to the base computer 12 via the WWW 18.

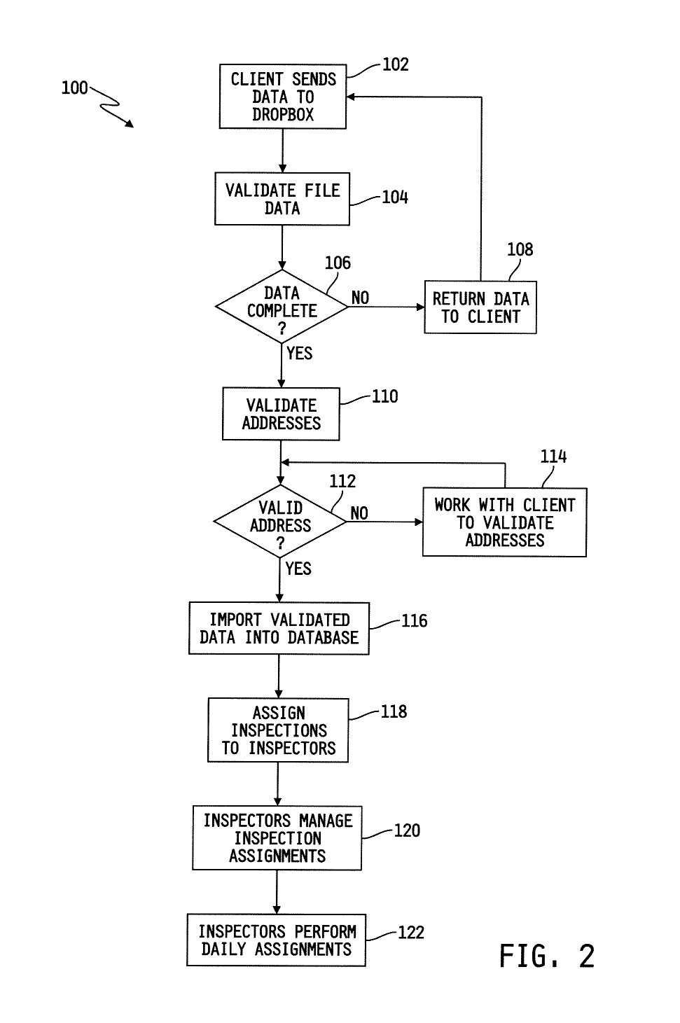

Referring now to FIG. 2, a flowchart is shown of one illustrative embodiment of a process 100 for managing property inspections, property inspectors and property inspection data. With the exception of the last step 122, the process 100 is illustratively stored in the memory unit 14 in the form of one or more sets of instructions repeatedly executable by the base computer 12 to control and manage property inspections, property inspectors and property inspection data. In the illustrated embodiment, the process 100 begins at step 100 where a client sends data in the form of a property inspection request to a predefined dropbox. In some embodiments, the client may execute step 100 by sending a completed property inspection request form to a predefined mailing address, and in other embodiments the client may execute step 100 by completing an on-line property inspection request form. In either case, the client-provided data is entered into the base computer 12, and the base computer 12 thereafter executes a validation process at step 102 in which the base computer validates that the client data contains certain information such as, for example, a valid name, address, account number or other unique client identifier, and/or the like. Thereafter at step 104 the base computer 12 determines whether the client has provided a complete set of data. If not, the process 100 advances to step 108 where control of the process 100 is returned to step 102 to request further or corrected data from the client. If, at step 106, the base computer 12 determines that the client data is complete, the process 100 advances to step 110 where the base computer 12 evaluates the address provided in the client data to determine whether the client-provided address is a valid address. In one illustrative embodiment, the base computer 12 executes step 110 by using conventional web-based tools to validate the client-provided address in real time. Thereafter at step 112, if the base computer 12 has determined that the client-provided address is invalid, the process 100 advances to step 114 where an exception report is generated and a representative contacts the client to resolve the address exception. If/when the client-provided address is validated at step 112, the process 100 advances to step 116 where the base computer 12 imports the validated address and other client-provided data into a database contained in the memory unit 14.

The process 100 advances from step 116 to step 118 where the base computer 12 assigns pending property inspections, i.e., requested property inspections that are to be conducted, to appropriate property inspectors based on one or more predefined criteria. For example, each of the pending property inspections stored in the memory 14 may include one or more attributes associated with the property to be inspected. The memory unit 14 further has a number of property inspector records stored therein each having data associated with the corresponding property inspector. One example criterion for assigning property inspections to be conducted to property inspectors to conduct them may be the zip code of the property to be inspected relative to the zip codes of the homes, offices or other designated locations, of the group of property inspectors from which to choose. In this example, the property inspector chosen to conduct a property inspection of a particular property may be chosen randomly from a group of eligible property inspectors having a home, office or other designated property with a zip code that matches that of the property to be inspected. One or more additional criteria may further be used, or one or more alternate criteria may alternatively be used, to filter the group of potential property inspectors when selecting a property inspector for inspection of a particular property. Examples of such additional or alternative criteria may include, but should not be limited to, property inspector rating, property inspector availability, number of property inspections conducted in the previous week, month or other time frame, and the like.

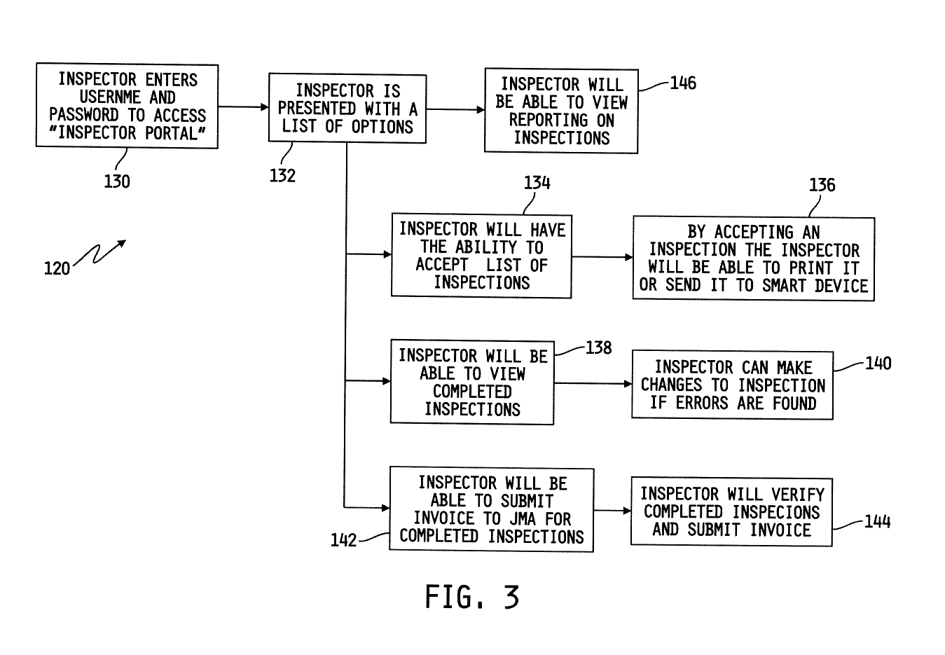

Following step 118, the process 100 advances to step 120 where the inspectors manage their inspection assignments made at step 118. As described hereinabove with respect to FIG. 1, the base computer 12 illustratively controls and manages a property inspector website, and approved property inspectors may access the property inspector website via a property inspector portal 20 using the WWW 18. Referring now to FIG. 3, a flowchart is shown of one illustrative process 120 for managing by the property inspectors of property inspections and property inspection assignments using the property inspector website available via the property inspector portal 20. The process 120 is illustratively stored in the memory unit 14 in the form of one or more sets of instructions executable by the base computer 12 to control and manage the property inspector website and to control and manage data exchanged with property inspectors via the property inspector website. In the illustrated embodiment, the process 120 begins at step 130 where a property inspector accesses the property inspector website via the portal 20 using a personal computer, laptop, notebook or tablet computer or other electronic device that is configured to access the WWW 18, and enters a predefined username and password. The process 120 presumes that, prior to execution of step 130, a property inspector will have been approved to use the portal 20 by issuing the property inspector a suitable username and password that will be recognized by the base computer 12 as an approved property inspector. In any case, when the property inspector enters a recognized username and password, the process 100 advances to step 132 where the website displays a list of options to select, e.g., in the form of selectable icons or the like. For example, the options may include steps 134 and 136 where the property inspector is provided a list of pending inspections which the inspector may accept or reject. Alternatively, the inspector may be presented with a list of pending inspections from which the inspector may accept or reject individual inspections from the list. In still other embodiments, the inspector may be presented with a list of assigned inspections at step 134 from which the inspector may not accept or reject but rather from which the inspector may select one or more inspections to conduct during the current day, week or other time period. In any case, the process 120 advances from step 134 to step 136 where the inspector may be provided with an option to send the details of one or more of the selected property inspections to the property inspector's mobile communication device 22 or to print a hard copy of a form which the property inspector may use to conduct the property inspection. In alternate embodiments, the list of options may include an option to send all assigned property inspections to the property inspector's mobile communication device or to print hard copies of forms for all assigned property inspections.

The options presented to the property inspector at step 132 may alternatively or additionally include steps 138 and 140 where the property inspector is provided a list at step 138 of property inspections previously conducted by the property inspector, any of which the property inspector may select for review. At step 140, the property inspector may then review and modify the results of the selected one of the previously conducted property inspections to correct errors, enter new information or the like.

The options presented to the property inspector at step 132 may alternatively or additionally include steps 142 and 144 where the property inspector is provided with a list at step 142 of completed property inspections from which the property inspector may select to submit an invoice to the system 100 for the inspection service. At step 144, the property inspector may verify completion of the selected property inspection and submit the invoice to the system 100 for payment. The system 100 may, for example, be configured to automatically disperse funds to the property inspector, or may instead require review of the completed property inspection report before dispersing funds to the property inspector.

Those skilled in the art will recognize alternative and/or additional options that may be provided by the base computer 12 to the property inspector at step 132, and any such alternative and/or additional options are contemplated by this disclosure. The process 100 advances from step 132 to step 146 where the web site may provide historical and/or other data to the property inspector that relate to that property inspectors assigned property inspections. Examples of such data may include, but should not be limited to, inspections assigned, inspections completed, inspections rejected, average number of days between assignment and completion of inspections, percentage of the property inspector's property inspections that passed quality control review, or the like. Those skilled in the art will recognize other historical and/or other data that may be presented to the property inspector at step 146, and such other historical and/or other data is contemplated by this disclosure.

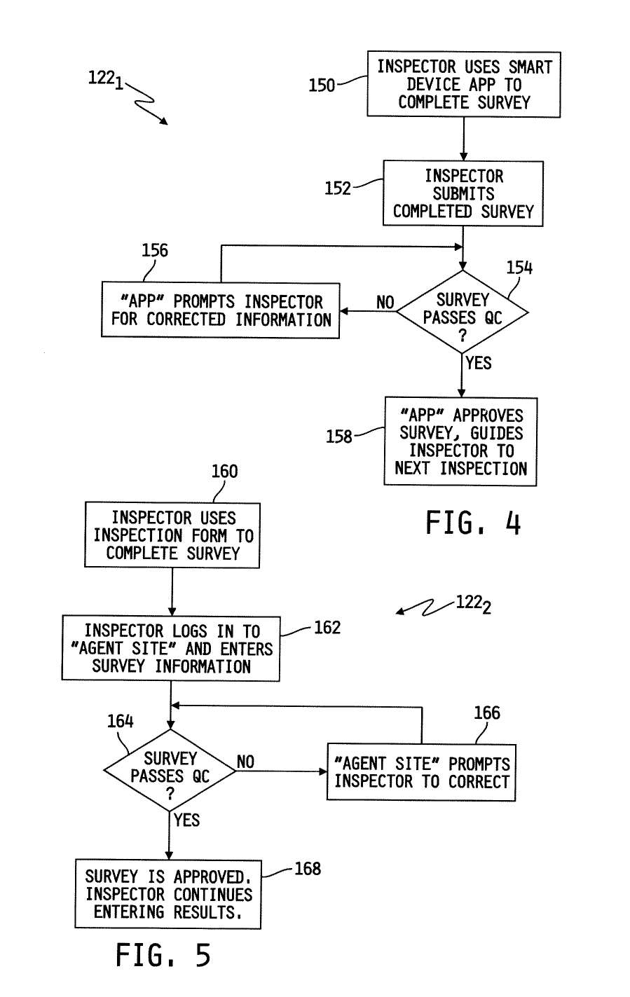

Referring again to FIG. 2, the process 100 advances from step 120 to step 122 where the property inspectors proceed to perform their daily assignments by conducting one or more of their assigned property inspections. Referring now to FIG. 4, a flowchart is shown of one illustrative embodiment of a process 122₁ that may be used by a property inspector at step 122 of the process 100 to conduct a property inspection using a mobile communication device 22. In this embodiment, the base computer 12 has transmitted the data file containing the details of the property inspection that is to be conducted to the property inspector's mobile communication device 12. The mobile communication device 22 includes a display, a processor and a memory having stored therein one or more sets of instructions, e.g., “app,” executable by the processor to control the display to provide graphic and textual instructions, messages and/or other information to guide the property inspector through the property inspection process. In the illustrated embodiment, the process 122₁ begins at step 150 where the property inspector invokes the property inspection “app” on the mobile communication device 22, e.g., a so-called “smart” device, and follows the guidance provided by the “app” to conduct the property inspection survey. Illustratively, the “app” guides the property inspector through the property inspection process and prompts the property inspector for responses to data requests and for photograph requirements. Part of the property inspection process includes the taking and attachment of photographs of various items associated with the property being inspected, and in this regard the mobile communication device 22 illustratively includes an on-board camera that the property inspector uses to fulfill the photographic requirements. In embodiments in which the mobile communication device 22 includes a GPS receiver, the “app” is programmed to geocode the GPS coordinates into the photograph files and to also timestamp the photograph files using the GPS-based time data. The “app” is further programmed to import the geocoded and time-stamped photos into the property inspection file for later transmission to the base computer 12 when the property inspection is complete.

The “app” further illustratively includes a quality control (QC) check or test, and upon completion of step 150 the property inspector submits at step 152 the completed survey to the on-board QC check or test. If, at step 154, the processor of the mobile communication device 22 determines that the submitted survey does not pass the QC check or test, the process 122₁ advances to step 156 where the “app” prompts the inspector for corrected information. If/when the processor of the mobile communication device 22 determines at step 154 that the submitted property inspection survey passes the QC check or test, the process 122₁ advances to step 158 where the “app” approves the property inspection survey. Illustratively, the “app” may then guide the property inspector to the next property inspection scheduled for the property inspector using, for example, an on-board GPS-based navigation application.

The QC check or test may check one or more aspects of the property inspection survey. Example aspects include, but should not be limited to, blank data fields, proper form of alphanumeric data, and the like. Illustratively, the QC check may further compare the geocoding contained in one or more of the photographs taken as part of the property inspection with known GPS coordinates of the property being inspected to ensure and validate that the property inspector physically conducted the property inspection at the appropriate property. In embodiments in which the photographs taken by the property inspector during the property inspection do not contain geocodes, the QC check may require the property inspector to provide an electronic signature certifying that the property inspection was physically conducted at the property in question, i.e., at the proper address. Those skilled in the art will recognize alternative and/or additional QC checks or tests that may be incorporated into the “app,” and any such alternative and/or additional QC checks or tests are contemplated by this disclosure.

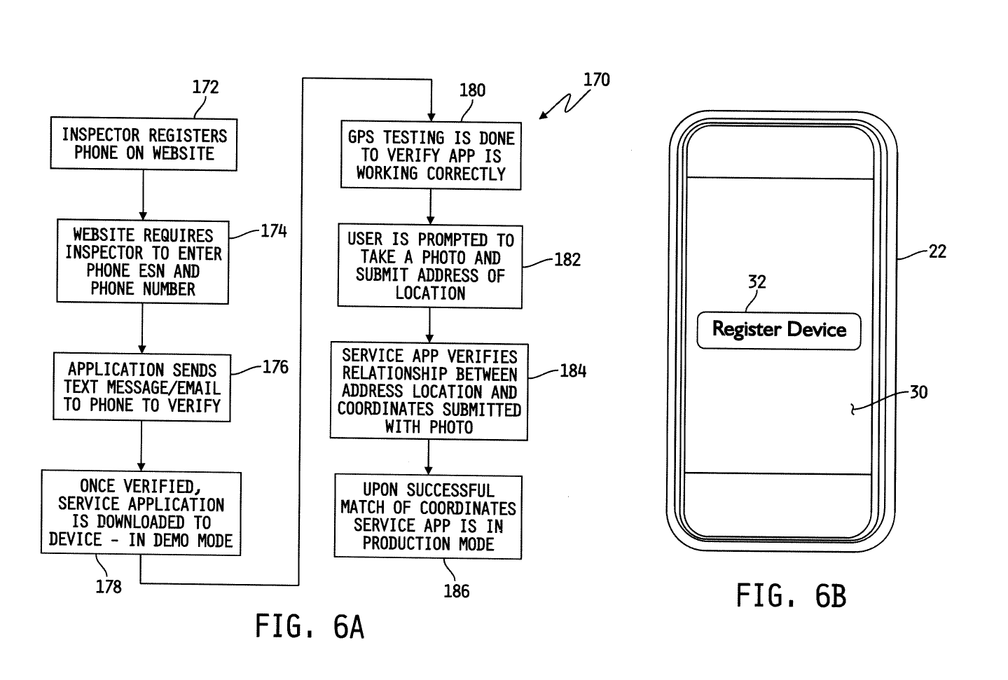

Referring now to FIG. 5, a flowchart is shown of another illustrative embodiment of a process 122₂ that may be used by a property inspector at step 122 of the process 100 of FIG. 2 to conduct a property inspection using a conventional property inspection survey and the property inspector portal 20 illustrated in FIG. 1. In this embodiment, the base computer 12 has made the data file containing the details of the property inspection that is to be conducted available to the property inspector via the property inspector or agent website. The property inspector has accessed the website, selected a property that has been assigned to the property inspector, and printed a property inspection survey containing information related to the selected property inspection as described briefly hereinabove with respect to FIG. 3. In the illustrated embodiment, the process 122₂ begins at step 160 where the property inspector uses the printed property inspection survey form to conduct the property inspection at the selected property. Thereafter at step 162, when the property inspection has been conducted and the property inspection survey form has been filled in with the details of the property inspection, the property inspector logs onto the property inspector or agent website, accesses the file for the property for which the property inspection has been conducted, and enters the information from the property inspection survey into the file. Illustratively, the website displays a suitable graphic interface to the property inspector during this process that facilitates entering of information from the property inspection survey form.

The website further illustratively includes a quality control (QC) check or test, and upon completion of step 162 the property inspector submits the completed survey to the QC check or test. If, at step 164, the base computer 12 determines that the submitted survey does not pass the QC check or test, the process 122₂ advances to step 166 where the base computer 12 prompts the inspector via the website for corrected information. If/when the base computer 12 determines at step 164 that the submitted property inspection survey passes the QC check or test, the process 122₂ advances to step 168 where base computer 12 approves the completed survey, and the property inspector may then enter the results of one or more additional property inspections or log off the website.

As discussed hereinabove with respect to FIG. 4, the QC check or test may check one or more aspects of the property inspection survey, and example aspects may include, but should not be limited to, blank data fields, proper form of alphanumeric data, and the like. In embodiments in which photographs taken by the property inspector during the inspection contain geocodes, the QC check may further compare the geocoding contained in the one or more of the photographs with known GPS coordinates of the inspected property to ensure and validate that the property inspector physically conducted the property inspection at the appropriate property. In embodiments in which the photographs taken by the property inspector during the property inspection do not contain geocodes, the QC check may require the property inspector to provide an electronic signature certifying that the property inspection was physically conducted at the property in question, i.e., at the proper address. Those skilled in the art will recognize alternative and/or additional QC checks or tests that may be incorporated, and any such alternative and/or additional QC checks or tests are contemplated by this disclosure.

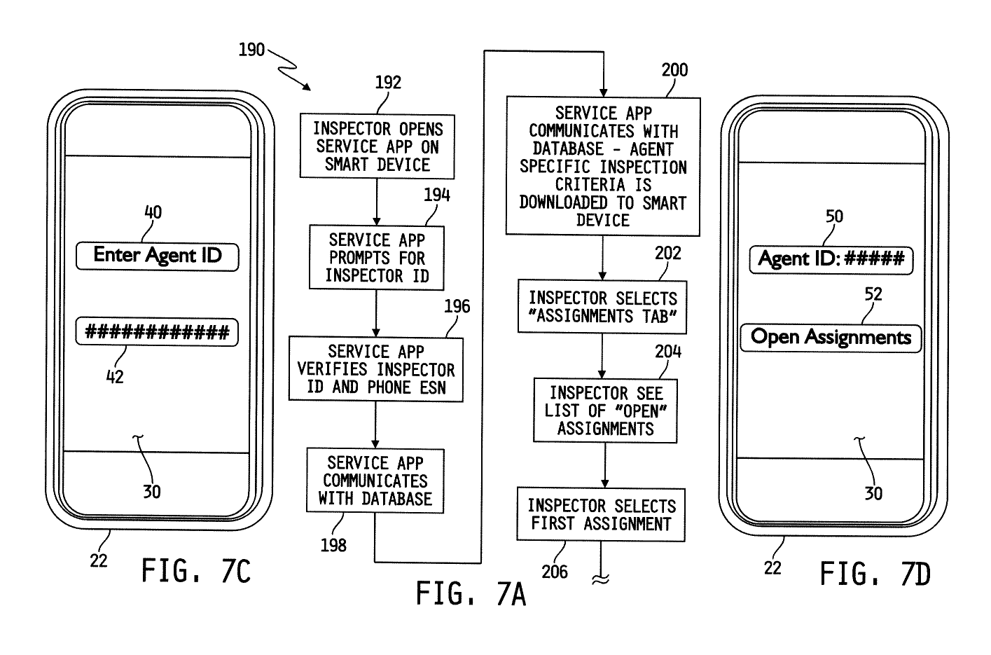

Referring now to FIG. 6A, a flowchart is shown of one illustrative process 170 for registering a mobile electronic device 22 with the system 10 of FIG. 1 for the purpose of conducting secure property inspections. The process 170 is executed in part by the processor of the mobile electronic device 22 and in part by the base computer 12. In the illustrated embodiment, the process 170 will be described for an example embodiment in which the mobile electronic device 22 is a smart phone, although it will be understood that the mobile electronic device 22 may alternative be embodied in the form of other mobile electronic devices as described hereinabove. In any case, the illustrated process begins at step 172 wherein the property inspector accesses a mobile communication device registration page of the property inspector (agent) website that is made available to the property inspector via the property inspector portal 20. Thereafter at step 174, the property inspector is prompted by the base computer 12 via the website to enter the electronic serial number (ESN) and 10-digit number of the smart phone. The base computer 12 may alternatively or additionally require other information at step 174, examples of which may include, but should not be limited to, one or more e-mail addresses accessible by the smart phone, one or more security codes associated with the smart phone and/or associated with the registration process, and the like. In embodiments in which the mobile communication device 22 is other than a smart phone, step 174 may require, for example, the property inspector to enter a serial number or other alphanumeric code unique to the device 22.

The process 170 advances from step 174 to step 176 where the base computer 12 sends a text message and/or e-mail to the smart phone, and the property inspector acknowledges the text or e-mail to verify the destination of the service application that will be downloaded to the smart phone to allow the property inspector to use the smart phone to conduct property inspections as briefly described hereinabove. When the base computer 12 receives the acknowledgement text or e-mail from the smart phone, the process 170 advances to step 178 where the base computer 12 downloads the service application to the smart phone, and the process of the smart phone stores the service application in an on-board memory. Following step 178, the service application will be available for use only in a so-called “demo” mode until further verification is completed as part of the registration process as set forth in steps 180-186. When the service application is accessed in the demo mode, the service application illustratively displays a message 32 on the display 30 of the device 22, e.g., “Register Device,” as illustrated by example in FIG. 6B, indicating that the device 22 must be registered to enable a production mode of the service application.

At step 180, the service application (or “app” as referred to hereinabove) undertakes a GPS test in the demo mode to verify that the app is working correctly. Thereafter at step 182, the service application prompts the property inspector to take a photograph with the smart phone and enter the address of the location of the photograph. Thereafter at step 184, the service application compares the address entered by the user with the geocode data of the photograph to verify the relationship between the entered address and the GPS coordinates of the photograph. If the GPS coordinates of the photograph match those associated with the entered address within a predefined error allowance, the process 170 advances to step 186 where the service application enables the full-function production mode of the service application.

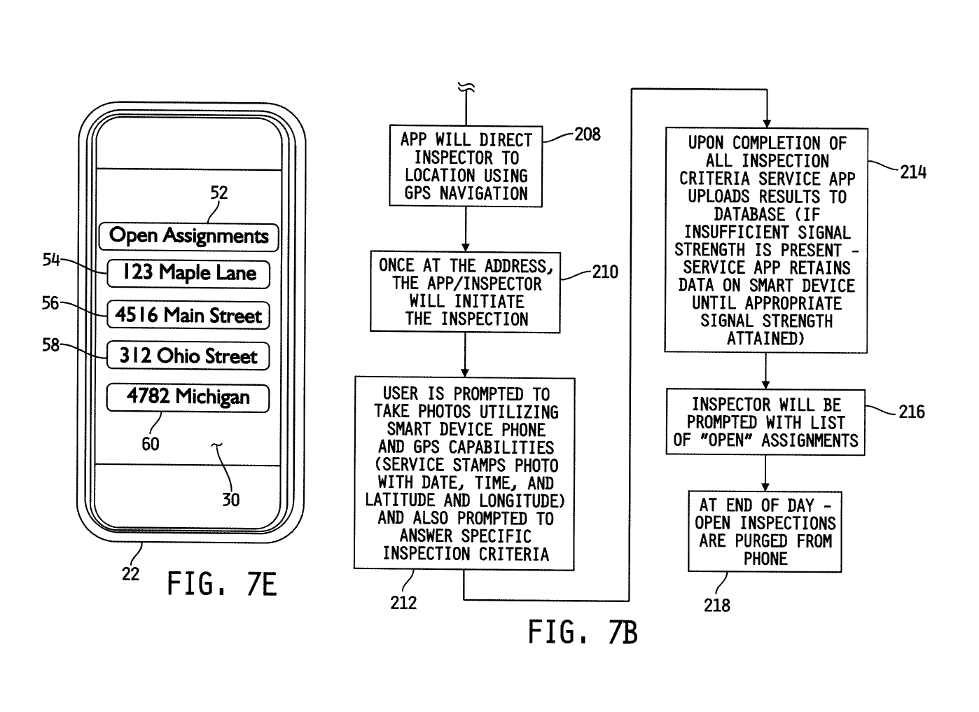

Referring now to FIGS. 7A and 7B, a flowchart is shown of one illustrative process 190 for conducting property inspections using a mobile electronic device 22. The process 190 illustrated in FIGS. 7A-7B is the production mode of the service application illustrated and described with respect to FIG. 6. In the illustrated embodiment, the process 190 begins at step 192 where the property inspector opens and launches the service application on the device 22 in a conventional manner. Thereafter at step 194, the service application illustratively controls the display 30 of the device 22 to prompt the property inspector via a suitable message 40 to enter the property inspector's identification number or code 42, as illustrated by example in FIG. 7C. Once entered, the process advances to step 196 where the service application compares the entered ID with one stored in memory, and if the two ID's match the service application verifies the match and phone ESN. Illustratively, the processor of the device 22 may control the display 30 to display the agent ID 50 as illustrated by example in FIG. 7D. Thereafter at step 198, the service application communicates with the database 14 via the WWW 18, and at step 200 the base computer 12 downloads property inspection assignments specific to the property inspector to the service application operating on the device 22. The processor of the device 22 illustratively controls the display 30 of the device 22 to produce a selectable icon 52 of open assignments. Thereafter at step 202, the property inspector selects the icon 52, and the processor of the device 22 illustratively controls the display 30 at step 204 to display a list of open assignments corresponding to addresses 54-60 of locations at which the property inspector is to conduct property inspections, as illustrated by example in FIG. 7E.

At step 206, the property inspector selects one of the addresses 54-60, and thereafter at step 208 the processor of the device 20 illustratively guides the inspector to the location of the address using conventional GPS navigation techniques. Once at the selected address, the property inspector initiates the property inspection at step 210. During the property inspection, the property inspector is prompted at step 212 to take a number of photographs using the camera on-board the device 22, and the processor stamps each of the photographs with the GPS coordinates of the device 22. The processor further illustratively time-stamps the photographs with time date obtained from the GPS satellites or from real-time clock data associated with the device 22. The processor further prompts the property inspector to answer and log certain specific property inspection criteria. Examples of property inspection information that the processor may prompt the property inspector to determine and log may include, but should not be limited to, one or more of the property inspection criteria items shown by in the following Table I, Table II and/or Table III.

TABLE I
Generic Home Inspection

| | |
|---|---|
| Item | Required Item |
| Photo 1 | Photo of Left Side of House |
| Photo 2 | Photo of Front of House |
| Photo 3 | Photo of Right Side of House |
| Photo 4 | Photo of Back of House |
| Photo 5 | Photo of Inside of House |

TABLE II

| Criteria | Responses | | | | |
|---|---|---|---|---|---|
| Occupancy | Occupied | Occupied by | Occupied by | Vacant | Partial Vacant— |
| Status | By Owner | Unknown | Tenant | | Multi-Unit |
| | Bad | No Access | | | |
| | Address | | | | |
| Occupancy | Contact | Visual | Neighbor | Meter | Mailbox |
| Verified by | Mail Carrier | Other | | | |
| If | Secured | Unsecured | Boarded | Lock Box | |
| Occupancy | | | | | |
| Status is | | | | | |
| Vacant, is | | | | | |
| the Home | | | | | |
| If | Interior | Exterior | Both | No | |
| Occupancy | | | | | |
| Status is | | | | | |
| Vacant, is | | | | | |
| the | | | | | |
| Personal | | | | | |
| Property | | | | | |
| Seen? | | | | | |
| If | Yes | No | Unknown | | |
| Occupancy | | | | | |
| Status is | | | | | |
| Vacant, is | | | | | |
| there a | | | | | |
| Pool? | | | | | |
| If | Yes | No | Unknown | | |
| Occupancy | | | | | |
| Status is | | | | | |
| Vacant, is | | | | | |
| Pool | | | | | |
| Secure? | | | | | |
| If | Above | In-Ground | | | |
| Occupancy | Ground | | | | |
| Status is | | | | | |
| Vacant, | | | | | |
| Type of | | | | | |
| Pool | | | | | |
| If | Yes | No | Unknown | | |
| Occupancy | | | | | |
| Status is | | | | | |
| Vacant, is | | | | | |
| Electricity | | | | | |
| On? | | | | | |
| If | Yes | No | Unknown | | |
| Occupancy | | | | | |
| Status is | | | | | |
| Vacant, is | | | | | |
| Gas On? | | | | | |
| If | Yes | No | Unknown | | |
| Occupancy | | | | | |
| Status is | | | | | |
| Vacant, is | | | | | |
| Water On? | | | | | |
| If | Yes | No | Unknown | | |
| Occupancy | | | | | |
| Status is | | | | | |
| Vacant, | | | | | |
| Hazards | | | | | |
| Present? | | | | | |
| Property | Fire | Storm | Flood | Boiler Explosion | Freeze |
| Damage? | Wind | Hail | Vandal | Roof Leak | Landslide |
| (Select All | Earthquake | Owner Neglect | Hurricane | Other | |
| the Apply) | | | | | |
| Property | Good | Fair | Poor | Violation | |
| Condition | | | | | |
| Construction | Brick | Stucco | Frame | Stone | Garage |
| Type | Concrete Block | | | | |
| Color | White | Beige/Tan | Brown | Green | Blue |
| | Yellow | Gray | Red/Pink | Natural | Other |
| Number of | One | Two | Three + | Split | |
| Stories | | | | Level | |
| Neighborhood | Improving | Declining | High Vandal | Stable | Unknown |
| Condition | | | | | |
| Building | Single | Duplex | Triplex | Quadplex | Condo/Townhome |
| Type | Mobile | Vacant Lot | Modular | | |
| Property | $0k-$100k | $100k-$200k | $200k-$500k | Over $500k | |
| Value | | | | | |
| Garage | No Garage | 1 Car | 2 Car | 3 Car + | Other |
| Type | | | | | |
| For Sale | Yes | No | | | |
| For Sale, if | By Owner | Real Estate | Unknown | | |
| Yes | | Company | | | |

TABLE III
Recommended Maintenance

| Criteria | Responses | | | |
|---|---|---|---|---|
| Board/Screen | Yes | No | Resecure | |
| Repair | | | | |
| Broken Windows | Yes | No | Resecure | |
| If Broken | No.______ | | | |
| Windows, Yes, | | | | |
| How Many? | | | | |
| Change Locks | Yes | No | Resecure | |
| If Change Locks, | No.______ | | | |
| Yes, How Many | | | | |
| Doors? | | | | |
| Cut Grass | Yes | No | | |
| If Cut Grass, is | Under 1 ft | Over 1 ft | | |
| Yes, How High? | | | | |
| Burst Water Line/ | Yes | No | Unknown | |
| Fixture | | | | |
| Secure Pool | Yes | No | Unknown | |
| Water Damage/ | Yes | No | Unknown | |
| Roof | | | | |
| Winterize | Yes | No | Unknown | |
| Remove Debris | Interior | Exterior | Both | None |

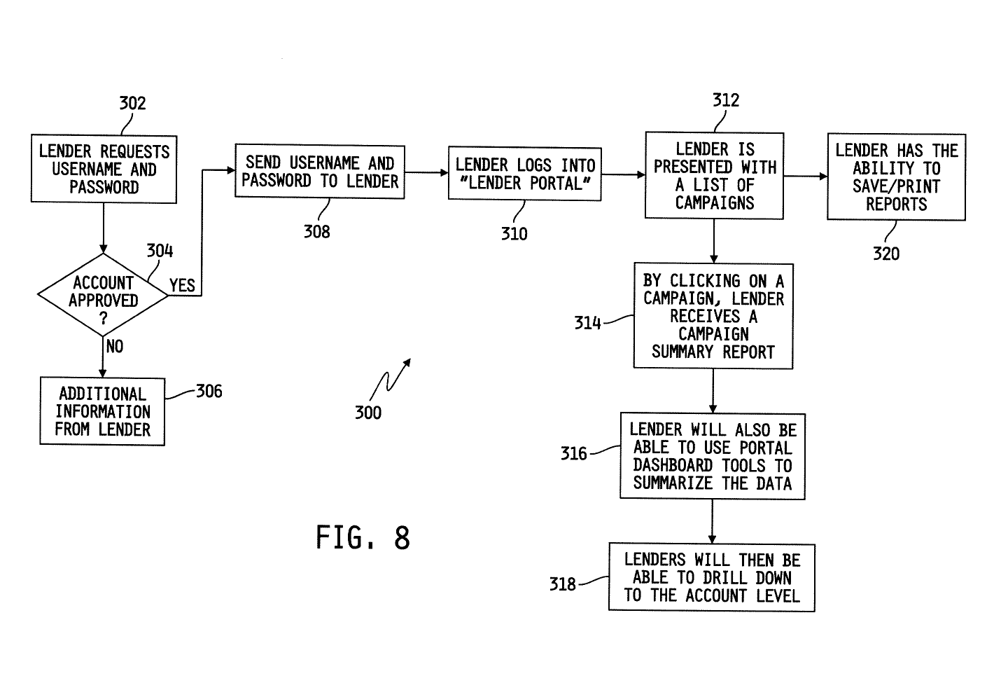

Upon completion of the property inspection, the process of the device 22 uploads the results of the property inspection at step 214 to the base computer 12 via the WWW 18, and the base computer 12 transfers the results of the property inspection to the database resident in the memory unit 14. In circumstances where the WWW 18 is not accessible, the processor of the device 12 maintains the results of the property inspection until the results can be transferred to the database of the system 10. Thereafter at step 216, the processor of the device 22 controls the display 30 to display the screen of open assignments as shown by example in FIG. 8, and the property inspector may choose one of the displayed addresses to conduct another property inspection. At the end of each day, or upon expiration of some other predefined time period, the processor of the device 22 purges all completed inspections resident in the memory of the device 22 at step 218 to ensure the security of the privacy and security of the property inspection data. Alternatively, the processor of the device 22 may be configured to purge each completed inspection resident in the memory of the device 22 after that completed inspection is transferred to the database of the system 10.

Referring now to FIG. 8, a flowchart is shown of one illustrative process 300 for managing property inspection data by lenders using the lender portal 16 illustrated in FIG. 1. The process 300 is illustratively stored in the memory unit 14 in the form of one or more sets of instructions executable by the base computer 12 to control and manage a lender/service provider website and to control and manage data exchanged with lenders and/or service providers via the lender/service provider website. In the illustrated embodiment, the process 300 begins at step 302 where a lender or service provider accesses the lender/service provider website via the portal 16. If the lender or service provider is not registered to access the website, the lender or service provider may request a username and password via the website. If the lender or service provider account is approved by the base computer 12, access is granted and the base computer 12 sends the approved username and password to the lender or service provider via e-mail or other suitable means at step 308. If the account is not approved by the base computer 12, the process 300 advances to step 306 where additional information is requested of the lender or other service provider.

Following step 308, the process 300 advances to step 310 where the lender logs into the lender/service provider website via the portal 16 using the lender/service provider's username and password. Thereafter at step 312, the base computer 12 presents via the lender/service provider with a list of campaigns via the website. The lender/service provider may select a campaign, and the base computer 12 responds to this selection by producing a campaign summary report at step 314. The summary reports may contain details of various aspects of property inspections, examples of which may include, but should not be limited to, number of inspections requested, number of inspections completed, number of inspections yet to be completed, percentage of inspections completed, percentage of inspections yet to be completed, information related to property vacancies, information related to properties for sale, and the like. At step 316, the base computer 12 makes available to the lender/service provider a number of dashboard tools that the lender/service provider may use to summarize the available data. Examples of data views that may be available via the dashboard tools may include, but should not be limited to, results by state, results by city, results by region, results by account, results by property type, and the like. At step 318, the base computer 12 further makes available to the lender/service provider customer account information, examples of which may include, but should not be limited to, customer account number, name and/or address, photographs produced during one or more inspections of the customer's property or properties, property inspection date(s), and details of one or more associated property inspections. At step 320, the base computer 12 provides the lender/service provider with the ability to save and print reports of any of the data from steps 314, 316 and 318.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A system for managing property inspections comprising:
a base computer,
a memory unit coupled to the base computer, the memory unit having stored therein a plurality of property inspection requests and a number of property inspector records, each of the plurality of property inspection requests including at least one attribute of a corresponding property to be inspected and each of the number of property inspector records including data associated with a corresponding property inspector, the memory further having instructions stored therein that are executable by the base computer to assign the property inspection requests to the property inspectors based on matches between the at least one attribute of the plurality of property inspection requests and at least one of the data associated with the number of property inspection records, and
a first web portal through which each of the number of property inspectors access their assignments of property inspections.

2. The system of claim 1 wherein the instructions stored in the memory further include instructions that are executable by the base computer to make the assignments of property inspection request available for access via a first website,
and wherein the number of property inspectors access their assignments from the first website via the first web portal.

3. The system of claim 2 wherein the instructions stored in the memory further include instructions that are executable by the base computer to control the first website to allow each of the number of property inspectors to securely access the first website, and to display the property inspection requests assigned to each property inspector when securely accessing the first website.

4. The system of claim 3 wherein the instructions stored in the memory further include instructions that are executable by the base computer to control the first website to allow each property inspector securely accessing the first website to accept or reject each of the property inspection requests assigned thereto.

5. The system of claim 3 wherein the instructions stored in the memory further include instructions that are executable by the base computer to control the first website to allow each property inspector securely accessing the first website to elect to send one or more of the displayed property inspection requests to a mobile communication device or to print the one or more displayed property inspection requests.

6. The system of claim 3 further wherein the instructions stored in the memory further include instructions that are executable by the base computer to control the first website to allow each property inspector securely accessing the first website to view and edit completed ones of the property inspection requests assigned thereto.

7. The system of claim 3 further wherein the instructions stored in the memory further include instructions that are executable by the base computer to control the first website to allow each property inspector securely accessing the first website to submit invoices for completed ones of the property inspection requests assigned thereto.

8. The system of claim 1 further comprising a second web portal through which each of a number of lenders or other service providers access data relating to property inspections.

9. The system of claim 8 wherein the instructions stored in the memory further include instructions that are executable by the base computer to make the data relating to property inspections available for access by the lenders and other service providers via a second website,
and wherein the number of lenders or other service providers access the data relating to property inspections from the second website via the second web portal.

10. The system of claim 9 wherein the instructions stored in the memory further include instructions that are executable by the base computer to control the second website to allow each of the number of lenders or other service providers to securely access the second website, and to display a list of campaigns containing the data relating to the property inspections to each lender or other service provider when securely accessing the website.

11. The system of claim 10 wherein the instructions stored in the memory further include instructions that are executable by the base computer to control the second website to display the data relating to the property inspection for any of the list of campaigns selected by a lender or other service provider securely accessing the second website, the data relating to the property inspection including at least one of a number of property inspections conducted, a number of assigned property inspections completed, a number of assigned property inspections not yet completed, a percentage of assigned property inspections completed, a percentage of assigned property inspections not yet completed, a number of the properties that are vacant and a number of properties for sale.

12. The system of claim 10 wherein the instructions stored in the memory further include instructions that are executable by the base computer to control the second website to allow the lender or other service provider securely accessing the website to view the data relating to the property inspections by at least one of state, city, region, account and property type.

13. The system of claim 10 wherein the instructions stored in the memory further include instructions that are executable by the base computer to control the second website to allow the lender or other service provider securely accessing the website to view data relating to property inspections of specific customers, the data including at least one of customer account number, customer name, customer address, photographs of the inspection requested by the customer, date of the inspection requested by the customer and a detailed description of the inspection requested by the customer.

14. A mobile communication device for conducting property inspections comprising:
a display unit carried by the device, and
a processor carried by the device and including a memory having a service application stored therein that is executable by the processor to control the display unit to guide a user through a property inspection and to prompt a user for input of data relating to the property inspection.

15. The mobile communication device of claim 14 further comprising:
a global positioning system (GPS) receiver carried by the device, and
a camera carried by the device,
wherein the data relating to the property inspection includes at least one photograph,
and wherein the instructions stored in the memory further include instructions that are executable by the processor to process signals received by the GPS receiver to determine GPS coordinates of the device and geocode the at least one photograph taken by the camera with the GPS coordinates when the processor prompts the user to take the at least one photograph pursuant to execution of the service application.

16. The mobile communication device of either of claim 14 wherein the instructions stored in the memory further include instructions that are executable by the processor to transmit results of the property inspection to a remote electronic system upon completion of the property inspection.

17. The mobile communication device of claim 16 wherein the device is configured to access the world wide web,
and wherein the instructions stored in the memory further include instructions that are executable by the processor to transmit the results of the property inspection to the remote electronic system via the world wide web.

18. The mobile communication device of claim 16 wherein the instructions stored in the memory further include instructions that are executable by the processor to temporarily store results of the property inspection in the memory, and to purge the results of the property inspection from the memory after the results of the property inspection are transferred to the remote electronic system.

19. The mobile communication device of claim 16 wherein the instructions stored in the memory further include instructions that are executable by the processor to temporarily store results of the property inspection in the memory, and to purge the results of the property inspection from the memory upon expiration of a predefined time period.

20. The mobile communication device of claim 15 wherein the instructions stored in the memory further include instructions executable by the processor to enable full operation of the service application only after verifying that the geocode of at least one photograph of a location taken by the camera matches known GPS coordinates of the location.
